(19) United States
(12) Patent Application Publication
(10) Pub. No.: US 2009/0005291 A1
(43) Pub. Date: Jan. 1, 2009

(54) Concentrated Fabric Conditioner Compositions

(76) Inventors: Richard Edward Bentley, Wirral (GB); Ian David Charlton, Bangkok (TH); David Stephen Grainger, Wirral (GB); Jane Howard, Wirral (GB); Jeremy Robert Westwell, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/087,303

(22) PCT Filed: Nov. 28, 2006
(86) PCT No.: PCT/EP2006/011474

§ 371 Date: Jul. 1, 2008

(30) Foreign Application Priority Data
Jan. 5, 2006 (GB) 0600144.0

(51) Int. Cl. C11D 3/26

(52) U.S. Cl. 510/527

(57) ABSTRACT

A method of making a fabric conditioning composition comprising providing: from 8 to 30% by weight of a quaternary ammonium softening material comprising a mixture of mono-ester, di-ester and tri-ester linked saturated components, a fatty complexing agent selected from fatty acids and fatty alcohols in an amount such that the weight of the mono-ester linked quaternary ammonium material to the fatty complexing agent is from 2.5:1 to 1:2, water, and perfume, the composition being free from non-ionic surfactant and added electrolyte, and subjecting the composition to a high shear and/or milling step.

### FIELD OF THE INVENTION

The present invention relates to concentrated fabric conditioner compositions and in particular to concentrated fabric conditioner composition which have desirable viscosity over a range of temperatures.

### BACKGROUND OF THE INVENTION

It is well known to provide liquid fabric conditioning compositions which soften in the rinse cycle.

Such compositions comprise less than 7.5% by weight of softening active, in which case the composition is defined as “dilute”, from 8% to about 30% by weight of active in which case the compositions are defined as “concentrated” or more than about 30% by weight of active, in which case the composition is defined as “super concentrated”.

Concentrated and super concentrated compositions are desirable since these require less packaging and are therefore environmentally more compatible than dilute or semi-dilute compositions.

A problem frequently associated with concentrated and super concentrated compositions, as defined above, is that the product is not stable, especially when stored at high temperatures. Instability can manifest itself as a thickening of the product upon storage, even to the point that the product is no longer pourable.

The problem of thickening upon storage is particularly apparent in concentrated and super concentrated fabric softening compositions comprising an ester-linked quaternary ammonium fabric softening material having one or more fully saturate alkyl chains.

A further problem known to affect concentrated and super concentrated and super concentrated fabric softening compositions comprising an ester-linked quaternary ammonium fabric softening material having one or more fully saturated alkyl chains is that the initial viscosity of a fully formulated composition can be very high, up to a point that the composition is substantially unpourable.

However, it is desirable to use ester-linked compounds due to their inherent biodegradability and to use substantially fully saturated quaternary ammonium fabric softening compounds due to their excellent softening capabilities and because they are more stable to oxidative degradation (which can lead to malodour generation) than partially saturated or fully unsaturated quaternary ammonium softening compounds.

Of the types of ester-linked quaternary ammonium materials known, it is desirable to use those based on triethanolamone which produce at least some mono-ester linked component and at least some tri-ester linked component since the raw material has a low melting temperature which enables the manufacturing process of the composition to occur at low temperatures. This reduces difficulties associated with high temperature handling, transport and processing of the raw materials and compositions produced therefrom.

The problem of high initial viscosity and visco-stability upon storage has previously been addressed in various ways.

Typical approaches to achieving stable concentrate products with good viscostability usually involve the use of non-ionic co-surfactants or electrolyte. Both approaches lead to thinning of the product which enables higher active level products to be manufactured. However, both can be problematic in that if excess salt or non-ionic is used, the long term stability of the product can be poor. Salt acts to screen the repulsive electrostatic charges between the bilayers and between the particles. Low levels of salt can be beneficial but high levels can lead to particle flocculation and thickening over time. Furthermore, even the use of low levels can be restrictive in terms of processing since it prohibits high shear milling beneath the phase transition temperature and in terms of including other benefit ingredients since the effects of the salt and the benefit ingredient on flocculation can be additive. Non-ionic surfactant is typically used to reduce the phase volume through changes to the microstructure. It changes the predominant form from micron sized liposomes to sub-micron discs or fragments. However, excess non-ionic surfactant can lead to the formation of significant levels of free micelles in the continuous phase. These micelles are believed to consist of non-ionic surfactant and solubilised components of the quaternary actives, giving the micelles and overall cationic charge. Such microstructures are then thought to cause thickening via a depletion type interaction. Excess non-ionic surfactant can also lead to thin undesirable products that are prone to separation on storage.

Furthermore two other aspects are especially desirable to successful manufacture of such concentrated fabric conditioners. First, the formulations must be robust to the typical range and levels of perfume components normally used in fabric conditioner formulations. Typical hardened tallow quaternary based fabric conditioners have limits to their perfume levels before instabilities begin to occur. Not only that, but historically there are also a number of perfume components that have had to be removed from perfume compositions because they impact the behaviour of certain non-ionic formulation aids (see for example the effect that eugenol and linalool have on the cloud point of ethoxylated non-ionics; Tokuoka et al, J. Coll. and Int. Sci, Vo; 152 (No. 2) p 402-409 (1992).

Secondly, there needs to be a robust means of controlling product viscosity through conventional processing techniques such as milling. One of the most desirable routes by which product viscosity is controlled is via high shear milling either towards the end or at the end of the process as it allows the operator more freedom to meet product specifications. This in turn reduces the amount of out-of-specification product that has to be reworked. Typically this approach has not been possible with concentrate products that do not contain non-ionic surfactant. This is believed to be because low temperature milling in the absence of non-ionic surfactant is though to cause the formation of highly viscous continuous lamellar phases.

Hence it is desirable to have robust formulations that:

i) can accommodate a wide range of perfume materials

ii) do not need either salt or non-ionic to achieve the required liquid properties and

iii) meet the specification requirements simply through a combination of formulation and processing.

Furthermore, it is also desirable to use fully saturated ester quaternary ammonium actives because:

i) they are biodegradable and

ii) they do not oxidise and hence do not discolour, suffer from oxidative malodours or need antioxidants.

It is known to employ fatty acids and/or fatty alcohols in fabric conditioner compositions comprising ester-linked quaternary ammonium compounds (hereinafter called ester quats).

U.S. Pat. No. 4,844,823 discloses quat:fatty alcohol levels in the range of 6.5:1 to 2.8:1.

WO2003/22972 discloses a method of preparing concentrated and dilute formulations based on ester quat fatty alcohol with a ratio of monoester quat (MEQ) to fatty complexing agent of 1:5 to 5:1 by including the perfume on or above the phase transition temperature to give better stability. The compositions preferably contain non-ionic surfactant and all of the Examples contain non-ionic surfactant.

WO2003/22970 discloses concentrated fabric conditioner compositions based on ester quats in combination with fatty complexing agent and non-ionic surfactant. The ratio of MEQ to fatty complexing agent is 5:1 to 1:5.

WO2003/22971 discloses dilutes (less than 7.5%) compositions based on ester quats in combination with fatty complexing agent for improved softening performance. The ratio of MEQ to fatty complexing agent is 5:1 to 1:5.

WO2003/22967 discloses a method of thinning concentrated fabric conditioner compositions based on ester quats via the addition of a fatty complexing agent in the ratio of 2.93:1 to 1:5 (MEQ to fatty complexing agent).

WO3003/057400 and WO2004/61066 disclose compositions comprising ester quats with polymer thickening agents. All of the compositions disclosed used unsaturated ester quats which can be manipulated more easily in concentrated formulations by use of an electrolyte.

It has now been found that concentrated fabric conditioner compositions which are robust to high shear processing/packaging, different perfume types and levels and possess desirable viscosity over a range of temperatures may be prepared from specific ingredients by mixing under high shear or by milling.

### SUMMARY OF THE INVENTION

According to the invention there is provided a method of making a fabric conditioning composition comprising providing:

from 8 to 30% by weight of a quaternary ammonium softening material comprising a mixture of mono-ester, di-ester and tri-ester linked saturated components,

a fatty complexing agent selected from fatty acids and fatty alcohols in an amount such that the weight of the mono-ester linked quaternary ammonium material to the fatty complexing agent is from 2.5:1 to 1:2,

water, and

perfume,

the composition being free from non-ionic surfactant and added electrolyte,

and subjecting the composition to a high shear and/or milling step.

Unlike many of the prior art compositions the invention does not employ non-ionic surfactants or electrolyte to control the viscosity of the fabric conditioning compositions. Instead, the invention allows fabric conditioning composition comprising hardened ester quats to be prepared by milling in the presence of specific amounts of fatty complexing agent. The compositions are tolerant of a wide range of perfume in a wide weight range.

### DETAILED DESCRIPTION OF THE INVENTION

The compositions of the present invention are preferably rinse conditioner compositions, more preferably aqueous rinse conditioner compositions for use in the rinse cycle of a domestic laundry process.

### Quaternary Ammonium Fabric Softening Material

The fabric conditioning material used in the compositions of the present invention comprises one or more quaternary ammonium materials comprising a mixture of mono-ester linked, di-ester linked and tri-ester linked saturated compounds.

By mono-, di- and tri-ester linked components, it is meant that the quaternary ammonium softening material comprises, respectively, a quaternary ammonium compound comprising a single ester-link with a fatty alkyl chain attached thereto, a quaternary ammonium compound comprising two ester-links each of which has a fatty alkyl chain attached thereto, and a quaternary ammonium compound comprising three ester-links each of which has a fatty alkyl chain attached thereto.

Below is shown typical levels of mono-, di- and tri-ester linked components in a fabric softening material used in the compositions of the invention.

| | % by weight of the raw |
|---|---|
| | material (TEA based |
| Component | softener with solvent) |
| Mono-ester | 10-30 |
| Di-ester | 30-60 |
| Tri-ester | 10-30 |
| Free fatty acid | 0.2-1.0 |
| Solvent | 10-20 |

The level of the mono-ester linked component of the quaternary ammonium material used in the compositions of the invention is preferably between 8 and 40% by weight, based on the total weight of the raw material in which the quaternary ammonium material is supplied.

Preferably, the average chain length of the alkyl group is at least C₁₄, more preferably at least C₁₆. Most preferably at least half of the chains have a length of C₁₈.

It is generally preferred if the alkyl chains are predominantly linear.

The preferred ester-linked quaternary ammonium cationic softening material for use in the invention is represented by formula (I):

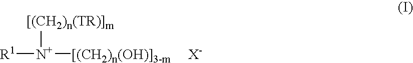

wherein each R is independently selected from a C₅₋₃₅ alkyl group, R¹ represents a C₁₋₄ alkyl or hydroxyalkyl group,

### T is

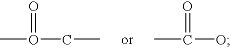

n is O or an integer selected from 1 to 4, m is 1, 2 or 3 and denotes the number of moieties to which it refers that pend directly from the N atom, and X⁻ is an anionic group, such as halides or alkyl sulphates, e.g. chloride, methyl sulphate or ethyl sulphate.

Especially preferred materials within this class are di-alkyl esters of triethanol ammonium methyl sulphate. A commercial example of a compound within this formula is Tetranyl® AHT-1 (di-hardened tallowyl ester of triethanol ammonium methyl sulphate 85% active).

### Excluded Quaternary Ammonium Compounds

Quaternary ammonium fabric softening materials which are free of ester linkages or, if ester-linked, do not comprise at least some mono-ester component and some tri-ester component are excluded from the scope of the present invention. For instance, quaternary ammonium compounds having the following formulae are excluded:

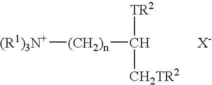

wherein R¹, R², T, n and X⁻ are as defined above; and

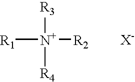

where R₁ to R₄ are not interrupted by ester-links, R₁ and R₂ are C₈₋₂₈ alkyl or alkenyl groups; R₃ and R₄ are C₁₋₄ alkyl or C₂₋₄ alkenyl groups and X⁻ is as defined above.

### Fatty Complexing Agent

The compositions of the present invention comprise a fatty complexing agent.

Especially suitable fatty complexing agents include fatty alcohols and fatty acids. Of these, fatty alcohols are most preferred.

Preferred fatty acids include hardened tallow fatty acid (available under the tradename Pristerene, ex Uniqema).

Preferred fatty alcohols include hardened linear C₁₆-C₁₈.

The fatty complexing agent is present in an amount greater than 0.5% to 15% by weight based on the total weight of the composition. More preferably, the fatty component is present in an amount of from 0.75 to 10%, most preferably from 1.0 to 5%, e.g. 1.25 to 4% by weight.

The weight ratio of the mono-ester component of the quaternary ammonium fabric softening material to the fatty complexing agent is from 2.5 to 1:2.

### Calculation of Mono-ester Linked Component of the Quaternary Ammonium Material

The quantitative analysis of mono-ester linked component of the quaternary ammonium material is carried out through the use of Quantitative ¹³C NMR spectroscopy with inverse gated ¹H decoupling scheme.

The sample of known mass of the quaternary ammonium raw material is first dissolved in a known volume of CDCl₃ along with a known amount of an assay material such as naphthalene. A ¹³C NMR spectrum of this solution is then recorded using both an inverse gated decoupling scheme and a relaxation agent. The inverse gated decoupling scheme is used to ensure that any Overhauser effects are suppressed whilst the relaxation agent is used to ensure that the negative consequences of the long t₁ relaxation times are overcome (i.e. adequate signal-to-noise can be achieved in a reasonable timescale).

The signal intensities of characteristic peaks of both the carbon atoms in the quaternary ammonium material and the naphthalene are used to calculate the concentration of the mono-ester linked component of the quaternary ammonium material. In the quaternary ammonium material, the signal represents the carbon of the nitrogen-methyl group on the quaternary ammonium head group. The chemical shift of the nitrogen-methyl group varies slightly due to the different degree of esterification; characteristic chemical shifts for the mono-, di- and tri-ester links are 48.28, 47.97 and 47.76 ppm respectively. Any of the peaks due to the napthalene carbons that are free of interference from other components can then be used to calculate the mass of mono-ester linked component present in the sample as follows:—

Mass_{MQ} (mg/ml)=(mass_{Naph}×I_{MQ}×N_{Naph}×M_{MQ})/(I_{Naph}×N_{MQ}×M_{Naph})

where Mass_{MQ}=mass mono-ester linked quaternary ammonium material in mg/ml, mass_{Naph}=mass naphthalene in mg/ml, I=peak intensity, N=number of contributing nuclei and M=relative molecular mass. The relative molecular mass of naphthalene used is 128.17 and the relative molecular mass of the mono-ester-linked component of the quaternary ammonium material is taken as 526.

The weight percentage of mono-ester linked quaternary ammonium material in the raw material can thus be calculated:

% of mono-ester linked quaternary ammonium material in the raw material=(mass_{MQ}/mass_{HT-TEA})×100

where mass_{HT-TEA}=mass of the quaternary ammonium material and both mass_{MQ} and mass_{HT-TEA} are expressed as mg/ml.

For a discussion of the NMR technique, see “100 and More Basic NMR Experiments”, S Braun, H-O Kalinowski, S Berger, 1^{st} edition, pages 234-236.

The non-ionic surfactant is preferably present in an amount from 0.01 to 10%, more preferably 0.1 to 5%, most preferably 0.35 to 3.5%, e.g. 0.5 to 2% by weight, based on the total weight of the composition.

### Perfume

The compositions of the invention comprise one or more perfumes.

The perfume is preferably present in an amount from 0.01 to 10% by weight, more preferably 0.05 to 5% by weight, most preferably 0.5 to 4.0% by weight, based on the total weight of the composition.

### Liquid Carrier

The liquid carrier employed in the instant compositions is water due to its low cost relative availability, safety, and environmental compatibility. The level of water in the liquid carrier is more than about 50%, preferably more than about 80%, more preferably more than about 85%, by weight of the carrier. The level of liquid carrier is greater than about 50%, preferably greater than about 65%, more preferably greater than about 70%. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and polyhydric (polyols) alcohols are also suitable carriers for use in the compositions of the present invention.

Co-Active softeners

Co-active softeners for the cationic surfactant may also be incorporated in an amount from 0.01 to 20% by weight, more preferably 0.05 to 10%, based on the total weight of the composition. Preferred co-active softeners include fatty esters, and fatty N-oxides.

Preferred fatty esters include fatty monoesters, such as glycerol monostearate. If GMS is present, then it is preferred that the level of GMS in the composition, is from 0.01 to 10 wt %, based on the total weight of the composition.

The co-active softener may also comprise an oily sugar derivative. Suitable oily sugar derivatives, their methods of manufacture and their preferred amounts are described in WO-Al-01/46361 on page 5 line 16 to page 11 line 20, the disclosure of which is incorporated herein.

### Polymeric Viscosity Control Agents

It is useful, though not essential, if the compositions comprise one or more polymeric viscosity control agents. Suitable polymeric polymeric viscosity control agents include non-ionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Non-ionic and/or cationic polymers are preferably present in an amount of 0.01 to 5 wt %, more preferably 0.02 to 4 wt %, based on the total weight of the composition.

### Further Optional Ingredients

Other optional non-ionic softeners, bactericides, soil-releases agents may also be incorporated in the compositions of the invention.

The compositions may also contain one or more optional ingredients conventionally included in fabric conditioning compositions such as pH buffering agents, perfume carriers, fluorescers, colourants, hydrotropes, antifoaming agents, antiredeposition agents, enzymes, optical brightening agents, anti-shrinking agents, anti-wrinkle agents, anti-spotting agents, antioxidants, sunscreens, anti-corrosion agents, drape imparting agents, anti-static agents, ironing aids and dyes.

### Product Form

In its undiluted state at ambient temperature the product comprises an aqueous liquid.

The compositions are preferably aqueous dispersions of the quaternary ammonium softening material.

### Product Use

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

It is also possible, though less desirable, for the compositions of the present invention to be used in industrial laundry operations, e.g. as a finishing agent for softening new clothes prior to sale to consumers.

### Preparation

The compositions of the invention may be prepared according to any suitable method.

In a first preferred method, the quaternary ammonium material, fatty complexing agent, and optionally the perfume are heated together until a co-melt is formed. Water is then heated and the co-melt is added to water with stirring and the composition subjected to high shear e.g. melting. Alternatively, the perfume can be added hot after the active ingredients have been added or can be added at different stages of cooling after active addition.

### EXAMPLES

The invention will now be illustrated by the following non-limiting examples. Further modifications will be apparent to the person skilled in the art.

Samples of the invention are represented by a number. Comparative samples are represented by a letter.

All values are % by weight of the active ingredient unless stated otherwise.

### Example 1

The samples reported in the following Table 1 were prepared:

TABLE 1

| | A | 1 | B | C |
|---|---|---|---|---|
| Quaternary 1¹ | 13.46 | — | — | — |
| HTTEAQ | — | 12.35 | — | — |
| Quaternary 3³ | — | — | 12.35 | — |
| Quaternary 4⁴ | — | — | — | 14.00 |
| Fatty Alcohol⁵ | 1.5 | 1.5 | 1.5 | 1.5 |
| Perfume | 1.32 | 1.32 | 1.32 | 1.32 |
| Minors | | | | |
| Water | to 100 | to 100 | to 100 | to 100 |

¹1,2 bis [hardened tallowoyloxy]-3-trimethylammonium propane chloride (78% active ingredient
²hardened tallow triethanolamine quaternary based on reaction of approximately 2 moles of hardened tallow fatty acid with 1 mole triethanolamine; the subsequent reaction mixture being quarternised with dimethylsulphate (85% active ingredient). The quaternary material contains approximately 20% by weight MEQ.
³bis(2-hardened tallowoyloxyethyl)dimethyl ammonium chloride (85% active ingredient)
⁴DHTDMAC or di-hardened tallow di-methyl ammonium chloride (75% active ingredient)
⁵Stenol 16-18L (ex. Cognis) and is hardened linear C₁₆-C₁₈ alcohol and is 100% active

All samples were prepared in a 3 Kg Vessel with recirculation loop. The process was as follows:

Water is heated in the vessel to 70° C. A molten premix of quaternary active and fatty alcohol was added over 3 minutes and stirred continuously for 4 minutes. Jacket cooling to 45° C. and then the perfume was added. Cooling to 31° C. (ambient). A portion of each sample was removed from the vessel without any milling. The remainder of the sample was milled. The equivalent of one batch volume or sample was milled via a Janke & Kunkel mill in the recirculation loop.

The short term viscosity stability of the samples is reported in the following Tables 2 and 3 which show the ambient temperature stability of samples (all viscosities are measured at a shear rate of 106 s⁻¹ on a Haake RT20 Viscoscometer).

TABLE 2
Unmilled examples

| | Example | | | |
|---|---|---|---|---|
| Time | Example A | Example 1 | Example B | Example C |
| Initial | 670 | 185 | 420 | gel |
| 1 day | — | 145 | 340 | gel |
| 10 days | 780 | 140 | 290 | not |
| | | | | measured |
| 18 days | 830 | 140 | 270 | not |
| | | | | measured |

The results from the unmilled samples clearly shows the benefits of HTTEAQ in that the base viscosities prior to milling are much lower than those of any other quaternary (in fact Example C was too thick to measure). Furthermore, unlike those of Example A they stay stable over the next 18 days of the test.

TABLE 3
Milled Samples

| | Example | | | |
|---|---|---|---|---|
| Time | Example A | Example 1 | Example B | Example C |
| Initial | 270 | 135 | 320 | gel |
| 1 day | — | 95 | 265 | gel |
| 10 days | 430 | 96 | 220 | not measured |
| 18 days | 477 | 92 | 195 | not measured |

Example C was still too thick to measure demonstrating that milling is unable to reduce the initial viscosity of the product. For Examples A, B and 1 the viscosities are reduced as a function of milling. However, it is clear that Example A is unstable as the viscosity begins to rise again. Conversely, Example 1 in accordance with the invention remains stable for the duration of the test.

### Examples 2 and 3

The samples reported in the following Table 4 were prepared.

TABLE 4

| | D | E | F | G | H | I | J | K | L | M | 2 | 3 |
|---|---|---|---|---|---|---|---|---|---|---|---|---|
| HTTEAQ | 13.5 | 13.5 | 13.5 | 13.5 | 13.5 | 13.5 | 12.35 | 12.35 | 12.35 | 12.35 | 12.35 | 12.35 |
| Fatty | 0.52 | 0.52 | 0.52 | 0.52 | 0.52 | 0.52 | 1.5 | 1.5 | 1.5 | 1.5 | 1.5 | 1.5 |
| Alcohol | | | | | | | | | | | | |
| Perfume | 0 | 0.88 | 1.32 | 0 | 0.88 | 1.32 | 0 | 0.88 | 1.32 | 0 | 0.88 | 1.32 |
| Minors (dye, | | | | | | | | | | | | |
| preservative) | | | | | | | | | | | | |
| Water | to | to | to | to | to | to | to | to | to | to | to | to |
| | 100 | 100 | 100 | 100 | 100 | 100 | 100 | 100 | 100 | 100 | 100 | 100 |
| Cold | No | No | No | Yes | Yes | Yes | No | No | No | Yes | Yes | Yes |
| Milling | | | | | | | | | | | | |

The HTTEAQ and fatty alcohol were as used in the previous Samples.

The Examples were subject to cold milling as in Example 1.

The ambient temperature stability of the Examples is reported in the following Table (all viscosities are measured at a shear rate of 106 s⁻¹ on a Haake RT20 Viscoscometer).

TABLE 5

| | Sample | | | | | | | | | | | |
|---|---|---|---|---|---|---|---|---|---|---|---|---|
| Time | D | E | F | G | H | I | J | K | L | M | 2 | 3 |
| Initial | 542 | 221 | 205 | 326 | 135 | 132 | 225 | 149 | 127 | 110 | 61 | 70 |
| 32 days | 590 | 210 | 224 | 382 | 104 | 132 | 360 | 157 | 121 | 89 | 74 | 69 |
| 67 days | 528 | 185 | 183 | 367 | 107 | 117 | 234 | 150 | 116 | 113 | 62 | 65 |
| 92 days | 548 | 180 | 176 | 371 | 105 | 113 | 238 | 142 | 111 | 108 | 63 | 64 |
| 206 days | 445 | 148 | 141 | 319 | 97 | 100 | 208 | 132 | 100 | 97 | 61 | 60 |

As can be seen from Table 5 cold milling reduces the viscosity of all the Examples as expected. There is no subsequent rising of viscosity after any length of time up to and beyond 6 months storage.

Examples of the invention exhibit lower final viscosities and hence require less milling and thus shorter batch times to achieve target viscosity.

The results show that stability of the formulations is not dependent in any way of the level of perfume.

### Example 4

The following formulation was prepared:

### 12.35% HTTEAQ

### 1.5% Fatty Alcohol

### 0.93% Perfume

Minors preservative, dye, antifoam

### Water to 100%

The HTTEAQ and fatty alcohol were as in the previous Examples. The formulation was prepared as in Example 1 and cold milled. Samples were taken off after 0, 1BV, 2BV and 2.5BV cold milling.

Viscosity as a function of cold milling (expressed in cps at both 20 and 106 s⁻¹)

### 0BV 830/300

### 1BV 330/135

### 2BV 177/80

### 2.5BV 116/54

The results show that product viscosity can be controlled through cold milling. Furthermore it shows there is no risk of shear induced flocculation as a function of more extended milling demonstrating the excellent robustness of the basic formulation.

1. A method of making a fabric conditioning composition comprising providing:
from 8 to 30% by weight of a quaternary ammonium softening material comprising a mixture of mono-ester, di-ester and tri-ester linked saturated components,
a fatty complexing agent selected from fatty acids and fatty alcohols in an amount such that the weight of the mono-ester linked quaternary ammonium material to the fatty complexing agent is from 2.5:1 to 1:2,
water, and
perfume,
the composition being free from non-ionic surfactant and added electrolyte,
and subjecting the composition to a high shear and/or milling step.

2. A method of making a fabric conditioning composition as claimed in claim 1 in which the composition is subject to cold milling.

3. A method of making a fabric conditioning composition as claimed in claim 2 in which the composition is subjected to cold milling for from 1 to 2.5 batch volumes.

4. A method of making a fabric conditioning composition as claimed in claim 1 in which the fatty complexing agent is a fatty alcohol.

5. A method of making a fabric conditioning composition as claimed in claim 4 in which the fatty alcohol is a hardened linear C₁₆-C₁₈ alcohol.

6. A method of making a fabric conditioning composition as claimed in claim 1 in which the quaternary ammonium softening material has the formula (I): 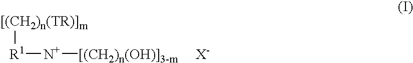
wherein each R is independently selected from a C₅₋₃₅ alkyl group, R¹ represents a C₁₋₄ alkyl or hydroxyalkyl group,
T is 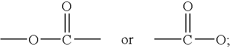
n is O or an integer selected from 1 to 4, m is 1, 2 or 3 and denotes the number of moieties to which it refers that pend directly from the N atom, and X⁻ is an anionic group, such as halides or alkyl sulphates, e.g. chloride, methyl sulphate or ethyl sulphate.

7. A method of making a fabric conditioning composition as claimed in claim 6 in which the quaternary ammonium softening material is hardened a tallow triethanolamine quaternary ammonium salt.

8. A method of making a fabric conditioning composition as claimed in claim 7 in which the quaternary salt is based on reaction of 2 moles of hardened tallow fatty acid with 1 mole triethanolamine followed by quaternisation.

9. A method of making a fabric conditioning composition as claimed in claim 8 in which the quaternary salt is conducted with dimethylsulphate.
